(19) United States
(12) Patent Application Publication
(10) Pub. No.: US 2022/0021264 A1
(43) Pub. Date: Jan. 20, 2022

(54) ELECTRIC MACHINE AND A STATOR WITH CONDUCTIVE BARS AND AN END FACE ASSEMBLY

(71) Applicant: Aeristech Limited, Warwickshire (GB)

(72) Inventors: Bryn Geoffrey Roddick Richards, Warwickshire (GB); Luke Read, Warwickshire (GB); Kevin Gray, Warwickshire (GB); Martin Palmer, Warwickshire (GB)

(21) Appl. No.: 17/478,716

(22) Filed: Sep. 17, 2021

Related U.S. Application Data
(63) Continuation of application No. 16/326,589, filed on Feb. 19, 2019.

(30) Foreign Application Priority Data
Aug. 19, 2016 (GB) 1614210.1

(51) Int. Cl. H02K 3/50; H02K 3/12; H02K 15/00; H02K 15/06; H02K 3/24; H02K 3/28

(52) U.S. Cl. CPC H02K 3/50; H02K 3/12; H02K 15/0081; H02K 2203/09; H02K 3/24; H02K 3/28; H02K 15/064

(57) ABSTRACT

An electric machine is described together with a stator. The electric machine comprises a stator, said stator comprising a cylindrical stator core having an end face; slots provided on the end face, each slot running through the stator core; a plurality of conductor bars disposed within the slots; and an end face assembly electrically connecting at least two of the conductor bars; a rotor having a plurality of magnetic pole pairs; and a controller electrically connected to said stator for regulating an excitation current supplied to or from the conductor bars, wherein the controller regulates an amplitude of the excitation current independently of a frequency of the excitation current. This arrangement simplifies stator construction and allows for optimisation of the electric machine.

This patent application is a continuation application of co-pending U.S. patent application Ser. No. 16/326,589, filed Feb. 19, 2019, which is a 371 nationalization of PCT/GB2017/052472, filed Aug. 21, 2017, which claims the benefit of GB 1614210.1 filed Aug. 19, 2016, the entire teachings and disclosure of which are incorporated herein by reference thereto.

### FIELD

An electric machine and a stator for a high speed, low inductance electric machine is described. In particular, an electric machine and a stator having a plurality of conductor bars and an end face assembly electrically connecting the conductor bars is described.

### BACKGROUND

Conventional electric machines (in the context of this disclosure, motors, generators and motor-generators) typically feature a rotor arranged within a bore defined by a hollow cylindrical core of a stator. The stator typically comprises a number of slots arranged within and concentrically about the core. A plurality of electrical wire windings form a conductive bundle of wire lengths, generally called a conductor, which provides an active role in carrying electrical current. The windings are then fed within and wound around the slots, to form a number of turns of the windings, each turn having two wire lengths or conductors. One or more turns placed within complimentary slots and connected in series define a coil that can be used to simplify construction. Additionally, each coil comprises two coil sides, each placed in a different slot. Accordingly, coils typically bundle together electrical windings that have been interwoven a number of times through the slots.

Slot winding patterns and configurations have become increasingly complicated and convoluted and dense as the power and control requirements of electric machines have increased. This is a particular issue in small motors, where manufacturing is complicated due to the typically small geometry. A controller is then used to regulate the supply or provision of current to or from the stator, depending upon the operating mode of the electric machine.

Modern electric machines, in this example referring to a motor (although similar observations apply to generators) are generally driven by a conventional pulse width modulated alternating current (AC) or brushless direct current (brushless DC) controller. Controller limitations in terms of the provision of current of a particular amplitude and frequency have driven electric machine design, leading to refinements in controllers, leading to refinements in machine design and so on. This has resulted in machines having an extremely complex winding pattern to attempt to accept (or generate) smoother waveforms supplied by controllers.

One counter example to the complex winding patterns prevalent in the art is shown in EP2112748. In this example, 4 solid bars are used within each stator slot. However, a complex series of connection end plates (8 per electrical phase) are then used to connect the bars to the electrical phases such that the bars within each slot are connected to multiple phases. Issues arise if too many end plates or bars per slot are used if these require soldering together.

It can be appreciated that this method greatly increases the cost of adding turns to the stator (the number of times a given phase passes through a given slot in series connection) compared to the relative cost of adding a turn in a conventionally wound stator, such that 4 conductors per slot raises serious concerns as to the feasibility of this approach for mass manufacture. Therefore, this method lends itself to applications that require a very low number of turns. Since in general (number of turns)×(motor speed)=(back EMF voltage), such applications are either for motors with a low-voltage power supplies (which are generally low-power and low-cost motors), or motors with high rotational speeds.

An alternative approach, such as that outlined in WO2011161408, moves away from pulse width modulation complex motor design by facilitating variation of the amplitude of excitation current to motor windings independently of the timing and duration of the excitation current. This controller architecture and control method is highly suited to motors and generators with high electrical switching frequencies. An electric machine is well suited to this control method if it exhibits some or all of a set of attributes including (most notably):
low inductance
a winding pattern compatible with square wave signals
magnets that are magnetised and laid out in a manner compatible with square wave signals
high electrical switching frequencies of the signals

In designing machines compatible with such controllers, design decisions may be taken which would typically be considered compromising for a machine in general driven by a conventional pulse width modulated (PWM) alternating current (AC) or brushless direct current (brushless DC) controller.

The following invention aims to provide an improved electric machine and an improved stator ideally suited to such a controller.

### SUMMARY

According to a first aspect of the present invention, there is provided an electric machine comprising: a stator, said stator comprising: a cylindrical stator core having an end face; slots provided on the end face, each slot running through the stator core; a plurality of conductor bars disposed within the slots, wherein an end of each bar protrudes outwardly from the end face; and an end face assembly receiving the ends of all the conductors bars, said end face assembly electrically connecting at least two of the conductor bars; a rotor having a plurality of magnetic pole pairs, said rotor located within the stator core; and a controller electrically connected to said stator for regulating an excitation current supplied to or from the conductor bars, wherein the controller regulates an amplitude of the excitation current independently of a frequency of the excitation current.

Armed with the design freedom allowed by a controller capable of high switching frequencies, the present invention can provide a hither motor voltage by increasing the number of series connected slots and by increasing the motor speed, rather than resorting to increasing the turn number within the stator, an approach that the present invention renders expensive, as discussed above.

According to another aspect of the present invention, there is provided a stator for a high speed, low inductance electric machine, said stator comprising: a cylindrical stator core having an end face; slots provided on the end face, each slot running through the stator core; a plurality of conductor bars disposed within the slots, wherein an end of each bar protrudes outwardly from the end face; and an end face assembly receiving the ends of all the conductor bars, said end face assembly electrically connecting at least two of the conductor bars.

It can be appreciated that embodiments or features described above and below in relation to the electric machine may be applicable to the stator alone, and vice-versa.

In an embodiment, the excitation current may comprise a plurality of phases. The controller may then be configured to supply the same phase of excitation current to each conductor bar disposed within a slot.

Optionally or preferably, one or more of the pluralities of slots within the stator form one or more electrical slot groupings or groups. Each grouping may be electrically connected to the controller in series, independently of other groupings. Each electrical slot grouping may also be energized by an excitation current having a separate electrical phase. In this manner, all bars within a slot may be connected to a single electrical phase.

The electrical phases may be connected to the conductor bars (directly or indirectly) in a delta or wye winding pattern.

Typically, in embodiments the controller comprises: a power supply for supplying an excitation current to the conductors bars; and a commutation controller, operationally independent of the power supply, and operative to control a timing and duration of supply of the excitation current to different conductor bars of the stator at any given time.

The power supply may comprise a current supply controller to control the amplitude of the current supplied to the conductor bars. The current supply controller may comprise a regulating current supply feedback loop for regulating the current amplitude supplied to the conductor bars dependent on a target speed of the motor.

Accordingly, the timing and duration of supply of the excitation current may be dependent on the angular position of the motor and the amplitude of the excitation current may be independently variable of the timing and duration of the application of the excitation current to the conductor bars.

The use of conductor bars, rather than standard coils made up of windings, together with an end face assembly to electrically connect the conductor bars allows the turn count in a motor (the number of times the conducting copper wires are wrapped through the winding pattern and pass through the magnetic field of the motor shaft magnets) to be reduced to the minimum (one pass) or near to the minimum (two or three passes or in any case fewer than normal for a given application design).

This simplification to the geometry allows opportunities for a reduction in the manufacturing cost of a low turn count stator compared to manufacturing in a more conventional manner with wound (copper) wires.

Reducing the number of turns in a stator reduces the motor constant, meaning that an electric machine produces less back EMF and passes more current for a given operating speed compared to the same motor with a higher turn count.

The present invention allows an increase in the number of magnetic poles in a machine and the number of slots in a machine's stator that is more than is necessary to satisfy any other design constraint, purely to allow control over the voltage:current ratio in a machine with a very low number of turns. In the context of a high-speed machine, this is notably unusual since it further increases the electrical frequency of signals passing in the machine, the frequency of which would already be excessively high in a high-speed machine. Such stators, however are suited to a controller that is not subject to stresses with increasing switching frequency to the same extent that more conventional controllers would be.

In embodiments, each bar of the stator individually fills approximately between approximately 60% to 90% of the volume of the slot. For contrast, a typical value for a typical stator is 40%. This allows a larger increase in the overall fill factor of the slots, without the typical disadvantages associated with a large fill factor using windings (complex winding patterns/construction and large amounts of winding overlap around the end face of the stator between slots). It can be appreciated that the bar may be made of several potential distinct bars, but it is intended by bar to mean one or more conductors that act as a single conductor when subject to an electrical connection.

In embodiments, one or two conductor bars are provided per slot. The conductors bars may be considered to be non-parallel conductor bars.

In particular, adopting a conductor bar approach instead of the conventional copper wire approach, allows the stator to achieve a good fill factor in the slots, and so it becomes possible to distribute the necessary quantity of copper (and quantity of current and arising electromagnetic flux) among a greater number of slots. This allows a greater quantity of smaller slots which: (a) allow the electromagnetic fields surrounding conductors to be smaller in diameter and to be conducted through a shorter total distance, saving ‘iron’ (the conducting medium for the flux) in the stator and reducing its size and cost); and (b) bring the average conductor closer to the magnets in the rotor (closer to the inner diameter of the stator), thereby making it much easier to achieve target torque density and efficiency levels. However, a larger number of slots tends to increase the switching frequency required of the controller (the electrical speed of the machine) relative to the (mechanical/actual) rotating speed of the machine.

A further benefit of using an end face assembly to electrically connect the conductor bars rather than winding the conductor bars around multiple slots is that the winding pattern can be greatly simplified—this arrangement is suited to motors/generators that provide a trapezoidal waveform that suits a square wave output. This allows for an increased power density. Trapezoidal waveforms may also help to reduce torque ripple. This waveform output typically comes from a 24 Slot, 8 pole design (with 90 electrical degree pole angle) i.e. pole angle/coil angle ratio=1.

As noted above, a square wave output may be used to drive the stator. One advantage of this arrangement is that a square wave output requires a reduced switching frequency as compared with Pulse width modulation. This, in turn, allows for thicker copper fill factor (i.e. thicker conductor bars) within the slots, to be used as skin depth is of less concern.

Additionally, a reduced switching frequency as compared with Pulse width modulation allows for increased number of poles, this allows for a single parallel magnetised magnet segment to be closer to the ideal case of radial magnetised magnet segment, this reduced torque ripple and increases power density without using more complex parts. A reduced current ripple caused by high pole count allows for reduced capacitor sizes.

In embodiments, the end face assembly receives ends of conductor bars, in particular ends to which the end face assembly is electrically connected. The ends of the conductor bars extend beyond the stator core. By receiving all of the ends of the conductor bar, the end face assembly provides a compact structure, adds to the structural rigidity of the stator core, and allows for the conductor bars (and therefore slots) to be electrically energised as desired using the electrical pathways within the end face assembly.

Each conductor may be a uniform solid bar, for example made of a single piece of copper. Each bar may be a rigid composite construction of laminated solid conductors. An enameled coating (with blanked off ends to allow for conduction) may be used. In one example, the coating may be coated in Kapton tape. The bar may be stamped or sheared from standard copper bar.

In an embodiment, the conductor bars may be received by cutaway sections within the end face assembly. This ensures a compact design and reduces the overall length of the stator.

The end face assembly may comprise one or more end face conductors for electrically connecting the conductor bars. Each end face conductor may comprise a conductive material encased in insulating material such that each end face conductor is electrically isolated. In this manner, end face conductors electrically connect selected conductor bars in the manner desired. For example, conductors within slots 1 and 4 of a 12 slot stator, each slot having a conductor bar within may be electrically connected using such an end face conductor. Similarly, conductors within slots 2, 7, 10 and 11 may be electrically connected. By electrically connected it is intended to mean that an electrical connection made between the end face conductors and an external supply energises all conductor bars electrically connected by an end face conductor.

In this manner, the electrical winding pattern is determined by the electrical connections made by the end face conductors of the end face assembly, rather than the actual winding pattern of electrical windings within the motor. This has the significant advantage of being easier to change—the ‘winding pattern’ (i.e. the arrangement of which slots are electrically connected or complimentary) can be changed without unwinding and removing the stator conductors, which in this case of electrical wiring is extremely time consuming.

The end face conductors may be sandwiched together. In this example, the end face conductors are typically plate structures, allowing several end face conductors to be stacked together whilst taking up the minimum of space in the main axis direction of the stator core. As each end face conductor is generally electrically isolated due to being encased in insulating material or spaced with an insulating spacer, several end face conductors can be stacked with each end face conductor operable to electrically connect different conductor bars.

In examples, each or the end face conductor is arranged to electrically connect two or more conductor bars to a single phase electrical signal. For example, in with a 3-phase power supply, 3 end face conductors may be used to selectively energise the conductor bars (and slots) to which they are connected. It can be appreciated that other number of conductor bars may be used depending on the configuration desired of the motor and the power supply used.

The end plate conductors may be segmented to form a discontinuous surface. In this way, several end face conductors may together form the plate structure described above. This provides a convenient way for electrical connections to be made between conductor bars and slots with the greatest ease and minimum space. Alternatively, or additionally, the segments within the end plate conductors may be considered to be bus bars for electrically connecting two or more conductor bars.

The bus bars or the end face conductors may comprise one or more apertures for receiving the end of a conductor bar. The apertures generally are uncoated and provide the electrical contact between the end face assembly and the conductor bars.

A cutaway may be provided within the end face conductors. Such a cutaway can provide a region for direct electrical connection of a controller and power supply to a conductor, such as using phase windings.

A neutral point may be provided by the end face conductors. Such a neutral point is typically where the brushings are provided to allow the motor to run at the same speed in both a forward and backward direction.

As described above, two or more end face conductors may be provided, each being separated and electrically isolated by an insulation layer.

The end face assembly may be configured to receive an external thermal plate used to cool the end face assembly. Thermal contact may be assured by allowing the end face assembly to abut against the thermal plate. It can be appreciated that a plate structure for the end face conductors that minimizes the distance between the stator core and any thermal plate is useful. Similarly, providing a flat plate structure for the end face assembly allows for a better thermal contact.

Additionally or alternatively, the end face assembly may comprise a heatsink for dissipating thermal heat away from the stator.

The end face assembly may be provided with a plurality of cooling channels for receiving a cooling fluid from a cooling system.

In a complimentary alternative or additional embodiment, the end face assembly may comprise a circuit board. The circuit board may be used to provide electrical pathways that allow the electrical connections between conductor bars within the slots. Providing an insulating substrate for the circuit board ensures that adjacent pathways or boards are electrically isolated from each other. As noted, the circuit board may comprise one or more electrical pathways, each electrical pathway electrically connecting two or more conductor bars. Each pathway may electrically connect conductor bars to a separate phase of an electrical supply. The circuit board may further comprise an external electrical connection for energising the connector bars.

In modem circuit board manufacturing, costs go up exponentially as the thickness (oz. of copper per square inch) increases beyond about 4. Let us say that 6 oz is a practical limit for a mass-produced item. Manufacturing problems and/or excessive costs are also encountered when moving beyond 12 total layers of conductor insulated from one another in the circuit board. So there is a practical limit of 6 oz per layer in max 12 layers. At least 2 layers in a circuit board is needed to create a motor with one conductor per slot. If 6 layers are used to create a 3-phase motor (having one phase per slot) with two turns (two conductors per slot)then 12×6 oz/2=36 oz conducting material in the end pieces for a single-turn motor are needed but only 12*6 oz/6=12 oz conducting cross section in a two-turn motor. Thus, losses would be higher in the two-turn motor. Accordingly, a 3-turn motor is less practical with a manufacturing method that uses circuit boards for the end pieces.

In examples, a plurality of slots may form one or more electrical slot groupings, each grouping being electrically connected to a controller in series, independently of other groupings. Each electrical slot grouping may then be energized by a current having a separate electrical phase. According, it can be appreciated that each electrical slot grouping may then be electrically connected by separate end plates.

Electric machines typically pass current through several slots in the stator and place the current in the presence of electric fields generated by several different magnets around the motor (in the radial direction). These different slots are typically (although not always) arranged in parallel. By arranging these in series, the total voltage across the machine increases and the total current passed by the machine decreases, which provides a more efficient motor.

As generally described above, the end windings of conductors of motors, which are normally bundles of copper wire carrying current from one slot to another around the ends of the stator, can be replaced by simpler geometries such as a circuit board or an end face assembly such as an insulated copper plate. This is particularly useful if the number of turns is low and most of the electrons travelling through the stator are in parallel (at the same voltage, capable of sharing the same conductor) rather than in series (at different voltages and requiring different conductors).

The slots may be separated by teeth within the stator core. The teeth may confine the conductor bars within the slot.

Each conductor bar may be a unitary piece of conducting material. Alternatively, each conductor bar may be a wrapped bundle of wiring, although in this case the number of wires that run from slot to slot is reduced or eliminated significantly compared to standard motor windings.

According to another aspect of the present invention, there is provided an electric machine comprising: a stator according to any example or embodiment described in isolation or in combination of the above aspects; a rotor having a plurality of magnetic pole pairs, said rotor located within the stator core; and a controller electrically connected to said stator for regulating current supplied to or from the conductor bars.

The controller may regulate an amplitude of the current independently of a frequency of the current. This allows the controller to more easily drive a motor suited to a square wave input, which allows for a lower switching frequency to be needed for the motor. This is a good fit for the described stator of the above described aspects.

In examples, a back EMF voltage arising from the current may be configured by altering the number of poles on the rotor and the number of slots in the stator in preference to altering the configuration and the number of conductors within each slot. This is unusual for motor design, which usually aims to alter the electrical winding_{—} pattern in preference to increasing the number of slots.

In another example, the rotational speed of the rotor may be equal to or greater than 50,000 rpm. The controller may regulate the current at a frequency equal to the rotational speed of the motor. The machine may also operates at a voltage between 10V and 200V, and with a current between 10 A and 200 A.

The machine may be either a motor, a generator or a motor-generator.

In a third aspect of the present invention, a forced induction system is provided comprising the machine of any part of the second aspect.

According to a fourth aspect of the present invention, there is provided a method of manufacturing a stator for an electric machine, said method comprising the steps of: providing a cylindrical stator stack, said stack having a hollow core and a plurality of slots provided on an end face, through the core, and around the core; mounting said stack on a stator assembly tool, said tool having a protrusion that is received within the core; inserting a plurality of conductor bars within the plurality of slots; and placing an end face assembly over the end face, said end face assembly electrically connecting two or more conductor bars.

The end face assembly may be formed by pressing or welding the end face assembly to the end face.

In examples, the conductor bars may be longer than a length of said stator stack such that end portions of the conductors protrude beyond said slots away from said end face.

The end face may comprise a plurality of apertures shaped to receive said end portions, said method further comprising the step of inserting the end portions of said conductors into the apertures.

The stator assembly tool may comprise an outer rim comprising a channel, wherein the outer rim receives the stator stack and the channel receives the conductor bars.

Aligning a portion of the end face assembly with a connection for a controller may also be a step in the manufacture.

As described above, a rigid bond between the conductor bars and the end face assembly, such as by welding, soldering, press-fitting or interlocking may be performed. This leads to a compact design when compared with traditional multiple wire turns around each slot and per conductor.

The method may further comprise the step connecting the end face assembly of the stator to a thermal plate, such that the end face assembly substantially abuts the thermal plate. Additionally or alternatively, the end plate assembly may comprise a plurality of cooling channels, such that said method further comprises the step of connecting the cooling channels to a cooling system.

This method allows for a reduced manufacture cost by negating the need for coil winding and insertion machines and coil forming machines. Additionally, the method allows build-up of the end-windings from individual components—i.e. by using an end face assembly, rather than the wirings within the slots. This has the further effect that the end winding subassembly of, for example a number of separate end face assemblies, may be manufactured separately and pressed onto the stator core.

These and other aspects of the invention will be apparent from, and elucidated with reference to, the embodiments described hereinafter.

### BRIEF DESCRIPTION OF DRAWINGS

Embodiments will be described, by way of example only, with reference to the drawings, in which

a. FIG. 1 illustrates a stator core having a plurality of slots according to an embodiment of the present invention;

b. FIG. 2 illustrates a stator conductor configured to be disposed within a slot of FIG. 1;

c. FIG. 3a shows an end plate assembly for receiving an end portion of the stator conductor of FIG. 2;

d. FIG. 3b shows a side view of the end plate assembly of FIG. 3a;

e. FIG. 3c shows an alternative end plate assembly of FIG. 3a according to an embodiment of the present invention;

FIG. 4 shows a schematic phase winding diagram according to an embodiment of the present invention;

g. FIG. 5 shows an exploded view of the stator core of FIG. 1, conductor bars of FIG. 2, end plate of FIG. 3 and an end plate assembler;

h. FIGS. 6a to 6g illustrate steps in constructing a stator;

i. FIG. 7 is a functional block circuit diagram of a control circuit used with and forming part of a machine of the present invention;

FIG. 8 is a block diagram showing a detail of the circuit of FIG. 7.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar feature in modified and different embodiments.

### DETAILED DESCRIPTION OF EMBODIMENTS

FIG. 1 shows a conventional stator stack or core 100. Said core is generally defined as a hollow cylindrical core, having a bore 102 for receiving a rotor (not shown) of an electric machine and an end face 104. Arranged within the end face 104 of the core are a number of slots 110. The slots 110 are arranged circumferentially around the bore 102 can be considered to be grooves formed within the core that run the length of the core. Teeth 112 are similarly formed between adjacent slots. The slots may be open to the core 102 or may be encased within the stator core.

The stator core is generally made of bonded laminations, such as electrical steel. The core can be stamped and bonded. These refer to the manufacturing process. Stamping is a way of cutting the laminated sections of the core out of a solid sheet of metal by a shearing action. Bonding typically involves gluing the laminated sections together to make a ‘stack’ (the core).

In a conventional stator arrangement, stator conductors, almost universally bundles of electrical windings and more typically bundles of copper wire, are wound around the teeth, through the slots, a plurality of times to fill a portion of the slots. Each wrap around by the windings may be considered to be a turn. In other words, the conductors are typically wrapped a number of turn's times around the stator. The greater the number of turns and the number or thickness of the windings within the slot, the higher the fill factor of the slot.

It can be appreciated that a higher fill factor provides a greater power response of the stator for a given current supplied to the windings, although hysteresis, resistive losses and other effects must be taken into account. Additionally, in conventional electric machine arrangements, only a portion of windings are energised at any given time, controlled by a commutation controller, with the intent of providing a smooth response of the engine. Pulse width modulation is often used to drive such a motor.

FIG. 2 shows the stator conductors 200 used in the present invention. Instead of copper windings, each stator conductor 200 is made of a single uniform bar, a conductor bar, formed of solid material or of a composite of laminated pieces electrically insulated from one another. Copper is a preferred material due to its electrical and thermal conductivity properties.

The conductor bar 200 is generally elongated in shape and shaped to substantially fill one slot 110 in the stator core. It can be appreciated that two or more bars may be placed within a single slot, with each bar filling approximately 25% or more of the volume of the slot. Typically, the total fill factor of copper for slots using bars is 80% compared to 40% with wires.

Enamel coatings are used to protect the bars and to electrically insulate each bar. Enamel itself is rarely used—enamelling is a commonly referred term to describe coating wires—polymers are generally used. Kapton tape is an alternative option. Said conductors may be stamped or sheared from a standard copper bar. This makes the bars relatively cheap to manufacture compared to copper wire. The conductor bars may be a composite construction of laminated solid conductors.

The bars are shaped to fit within the slots, although end sections or portions 210 are configured to protrude beyond the stator core away from the end face 104 to provide electrical connections and allow conduction. The end portions 210 are generally free of enamelling.

In addition to the stator core and the conductor bars, an end face assembly 300 is provided as shown in FIGS. 3a and 3b. The end face assembly 300 shown is a two layer end face assembly, although additional layers can be provided. The end face assembly 300 may be considered to be an end plate assembly, with each layer 310, 320 providing a separate end plate. Insulation layers 330, 332 are used to separate the end plates 310, 320, although each end plate may be encased in insulation either in addition or instead.

The end plates 310, 320 as shown are cylindrical plate structures having a disc like shape substantially matching the end surface shape of the stator core. The end plates provide a capping to the end structure of the core and the conductor bars 200.

The end face assembly 300 electrically connects two or more conductor bars 200 that are disposed in electrically complimentary slots. This means that the end face assembly 300 acts to electrically connect conductor bars between slots such that an electrical current supplied to one of the conductors is also provided to any other electrically connected conductor bar, via the end face assembly. Accordingly, each end plate can be configured to be electrically associated with a particular phase of electrical supply (so a particular phase current). Alternatively or additionally varying current amplitudes may be supplied to each end plate.

As shown in FIG. 3a, the end face assembly has a number of cutaway sections 340 for receiving end portions of the conductor bars 200. The cutaway sections are shown as slots or channels within the external surface of the assembly.

In the example shown, each end plate is sandwiched together, with the cutaway sections aligning to allow the conductor bars 200 to be received by both end plates 310, 320.

The end plates are typically made from (or coated by) an insulating material. Ceramics may be used. Conductivity between the conductor bars is provided by conductive paths such as bus bars (described below) or electrical pathways such as electrical circuits and circuitry.

In the case of bus bars, these can be shaped, insulated, or attached to contact only certain conductor bars within certain slots, to achieve the same effect. Bus bars can be selectively welded, soldered, mechanically pressed, or otherwise connected to only certain parts or portions of the conductors in the stator slots. It is notable that soldering materials can be obtained with different melting temperatures so that a set of soldering connections could be made (for example in an oven) using one soldering material and a different set of soldering connections could be made using a different soldering temperatures with a lower melting point, so that the second soldering process need not disturb the first soldering process. In this way, complex connecting patterns can be built up within a small space.

As an alternative or complimentary example, circuit boards (of one or more layers) can provide electrical conducting pathways (“tracks”) to transfer current from one or more of the conductors in one slot to one or more of the conductors in a different slot. In this instance, the circuit board comprises an insulating substrate with a series of electrical pathways or wirings that electrically connect conductor bars 200 in the manner previously described. The use of an electrical circuit board may help to reduce the overall size of the stator and associated systems.

The end plates 310, 320 are arranged to electrically connect conductor bars 200 to a single phase of an electrical signal. The electrical signal is typically a three phase electrical signal.

In the example shown, wach end plate comprises a number of bus bars 350, 360. The bus bars act to provide an electrical path between conductor bars 200 via conductivity pathways formed between the slots and the bus bars. The bus bars are configured to have similar slots or cutaway portions as the end plates 310, 320 the bus bars provide a discontinuous segmented face for the end plate. In this manner it can be appreciated that the bus bars, via the end plates, act to energise the conductor bars in the appropriate order matching the distribution of magnets on the shaft and allowing the electric machine to generate torque.

An alternative construction of end plate 300 is shown in FIG. 3c. End plate 370 differs from assembly 300 in that a cutaway region 380 is provided that does not use a bus bar. Instead, the cutaway region of 380 provides a connection point for a controller to supply, regulate and/or collect electrical current to the conductor bars either directly or via the end plate assembly.

A neutral point is also shown in FIG. 3c at 385. In the configuration shown, the neutral point (a point where brushings can be placed to energise the stator such that the forward and reverse speed of the motor is the same) is at the bus bar that spans three conducting bars.

It can be appreciated that further layers of insulation and further conductors and layers of insulation (or additional tracks on a circuit board) can be added to the end winding to allow more than one conductor per slot connected in series (typically called an additional “turn” in the stator). However, the number of series conductors (“turns”) will be limited, typically only one conductor per slot and rarely more than four.

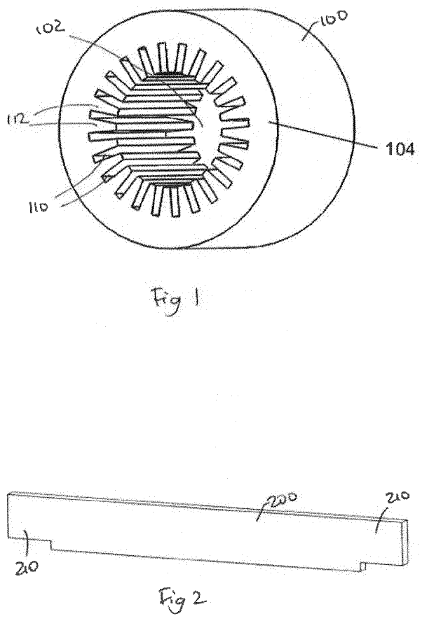

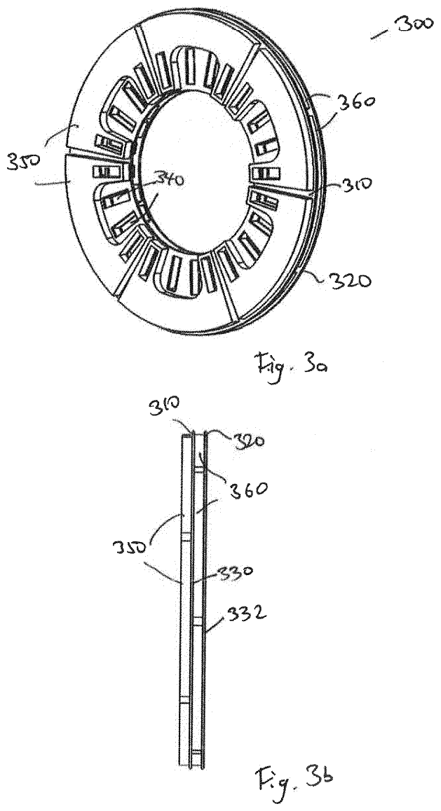

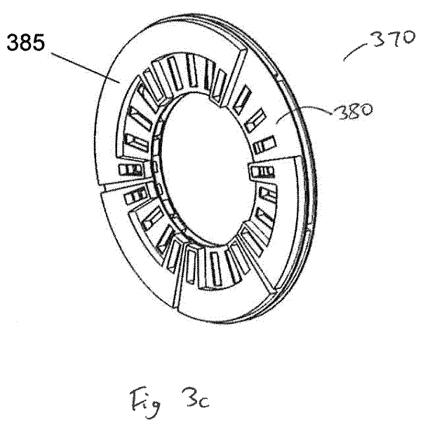

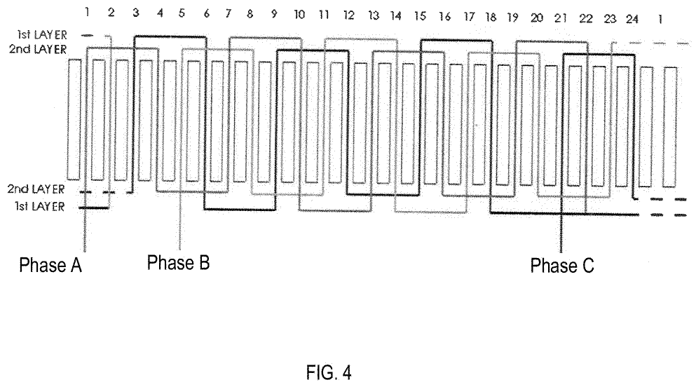

FIG. 4 shows a stylised view of the electrical pathways within the stator. In the example shown, a 24 slot stator is provided with a 3-phase electrical supply. The electrical supply is provided and commutated using a controller.

In the example shown, each slot is electrically associated with a single phase electrical supply or current. For example, slots 1, 4, 7, 10, 13, 16, 19 and 22 are electrically connected to phase 1; slots 2, 5, 8, 11, 14, 17, 20, 23 with phase 2 and slots 3, 6, 9, 12, 15, 18, 21, 24 with phase 3. Other configurations are of course possible. However, the number of turns (I.e. the overlap between conductor bars and the slots should be minimised. In the example shown, a single conductor is provided per slot and a single turn is shown (i.e. each slot is electrically connected to a single phase current).

As seen in FIG. 4, the slots are arranged in series such that the electrical pathway passes directly from and between each complimentary electrical slot. This ensures that all electrons within a slot are travelling with the same vector current (i.e. in the same direction).

Practical limitations on the number of parallel conductors per slot in this winding method mean that the method lends itself to trapezoidal current wave forms, especially the extreme case where the number of slots is divisible by the number of magnet poles and each slot of the stator contains conductors of only one phase of stator winding. In order to reach high speeds for the rotor, a controller capable of handling such signals is necessary and used. Such signals are substantially square waves (typically referred to as “six step bridge” commutation of the controller). A controller capable of independently providing an amplitude of current independent on the frequency of the current is ideally suited (i.e. a simple six step bridge with separate control of amplitude).

Due to the high fill rate of the slots (typically 80% as compared to 40% of conventional stators) the efficiency of the motor is improved. On factor tending towards higher efficiency is a shorter conduction path length for electromagnetic flux through the iron around the electrical. Additionally, the response of the motor to electrical current is also improved. This lowering of the number of turns in a stator reduces the motor constant, meaning that an electric machine produces less back EMF and passes more current for a given operating speed compared to the same motor with a higher turn count.

A motor designer limited to a small turn count motor can nevertheless regain some control over the ratio of voltage to current in the electric machine by arranging stator slots in series as shown in FIG. 4. Electric machines typically pass current through several slots in the stator and place the current in the presence of electric fields generated by several different magnets around the motor (in the radial direction). As noted above, these different slots are typically (although not always) arranged in parallel. By arranging these in series, the total voltage across the machine increases and the total current passed by the machine decreases. However in this invention a motor designer can increase the number of magnetic poles in a machine and the number of slots in a machine's stator more than is necessary to satisfy any other design constraint, purely to allow control over the voltage:current ratio in a machine with a very low number of turns. This is possible due to the high fill factor of the motor and the use of a suitable controller that is tolerate of high switching frequencies, typically a controller that produces square wave output via a six step bridge, or a similar controller that is tolerant of (or capable of) high switching frequencies.

In the context of a high-speed machine, this is notably unusual since it further increases the electrical frequency of signals passing in the machine, the frequency of which would already be excessively high in a high-speed machine. As noted above, this unusual step can be explored by a controller that is uniquely not subject to stresses with increasing switching frequency to the same extent that more conventional controllers are.

FIG. 5 shows an exploded overview of both the stator core 100, conductor bars 200 and end face assembly 300, as well as a method of constructing the stator using a stator assembly tool 510. As can be seen, a plurality of conductor bars 200 equal to the number of slots within the stator core 100 are provided.

Details of the method are described below in reference to FIGS. 6a to 6g. FIG. 6a shows the stator assembly tool 510, stator core 100, conductor bars 200 and end plate 300 in cross-sectional view. In a first step these components are provided. The stator core is then mounted onto the stator assembly tool 510. The assembly tool 510 comprises a central protrusion 512 shaped to fit within the bore 102 of the substantially cylindrical hollow stator core 100. The assembly tool further has a base 514 from which the protrusion 512 protrudes and an outer protrusion or rim 516. The base 512 provides a shoulder or flange 514 extending away from the external surface of the periphery of the protrusion and acts as a stop to regulate and control the relative positions of the conductor bars relative to the stator assembly tool to ensure that when each stator conductor is slid into the slots a predefined amount of uncoated conductor is exposed.

Once coupled, the conductor bars 200 are slid into position through the slots. The outer protrusion or rim 514 acts the control the relative positions between the stator 100 and the assembly tool 510 to leave sufficient space between the rim 516, the protrusion 512 and the base 514 for the conductors 200.

At the next step, the end plate 300 is free to be engaged with the conductors 200 and stator core 100. The end plate 300 is first aligned and then pressed or secured by any reasonable means to the stator core. The stator assembly tool can then be removed and used in assembly of the opposing side as shown in FIGS. 6e and 6f. The final assembled stator is shown in FIG. 6g. The end plate 300 is typically installed as a unitary piece, however it may be installed in parts depending upon the design of the end plate.

A preferable controller for use with the stator described above is shown in FIG. 7. A principle feature of this controller 80 is that it addresses power separately from commutation. This control approach is achieved by a logical separation between the control of aggregate current i1 82 flowing to a motor 84 and the commutation of that current iu, iv, iw 86a-c on the phase connectors of the motor 84. The motor 84 in this instance has the stator arrangement described above, namely having bar conductors within the slots. The controller is electrically connected to the end plate assembly of the stator. In particular, the controller is electrically connected to energise each end plate assembly with an excitation current having a single phase. The aggregate current 82 has two proportional-integral (PI) feedback control loops 88, 90 that regulate aggregate current 82.

The inner loop 88 controls the current amplitude directly and the outer loop 90 adjusts the current in response to the torque requirement (speed/target speed mis-match) of the motor 84. The inner loop 88 comprises a duty cycle 92 that provides the amplitude of the aggregate current 82 and a (amplitude) regulator 94 that compares the present aggregate current 82 to the current requested by the outer loop 90. If the aggregate current 82 requested by the outer loop 90 is greater than the currently supplied aggregate current then the current is adjusted to match the desired current by the duty cycle 92. It can be appreciated that the inner loop 88 can be considered to be a regulating feedback loop for regulating the current amplitude.

The outer loop 90 also comprises a (speed) regulator 94 that compares a speed target 96 with the current speed of the motor 84 and determines the aggregate current 82 required to accelerate to the speed target 96. A saturation check 100 is provided to ensure that the current requirements are within the capability of the controller 80 and the motor 84. The speed of the motor is provided by a FN converter 102 that analyses back EMF signals Vw, Vv, Vu 104 obtained from the motor and converts them to determine the motor speed 98 and the angular position of the motor (and the magnets). The components used to regulate the aggregate current 82 (the inner and outer feedback control loops 88, 90) may be considered as a current supply feedback loop for providing a current amplitude to the motor 84 conductors.

This two-tier approach is implemented in order to prevent an over-current condition, because the motor 84 is optimally designed for very low internal inductance and is therefore highly sensitive to damage unless current 82 is tightly controlled on a short timescale. To control speed 96, the control system 80 measures the frequency of the motor back EMF 104 to get the motor speed 98. By setting the current command 90 to the inner loop 88, the control system can control the torque. If the motor 84 needs to accelerate, the controller 90 will increase the current command to increase the torque. The commutation of the aggregate current 82 is implemented separately and is shown to the right of the motor 84. The commutation pattern 110 responds passively to the motor position as measured by tracking the back-EMF 104 displayed on the phase connectors.

The preferred embodiment uses the phase-to-phase voltage to measure back-EMF. This would normally lead in phase by 90 degrees relative to the optimal current commutation timing, based on the typical properties of motors (see below). The preferred embodiment therefore implements a low-pass filter 112 which produces a 90 degree phase shift in the measured phase-to-phase voltages. This low-pass filter 112 additionally removes errors from the back-EMF signal 104 and simultaneously adjusts the phase angle so that the timing is appropriate for use as a current commutation control signal. Once the commutation pattern 110 is determined, it is provided to the IGBT module 114. The aggregate current 84 can then be regulated by the IGBT module 114 in the required commutation pattern 110 to deliver the required current iu, iv, iw 86a-c to the motor 84. This combination of components 110, 112 and 114 act as a commutation feedback loop for controlling the timing and duration of excitation current supplied to the motor bar conductors.

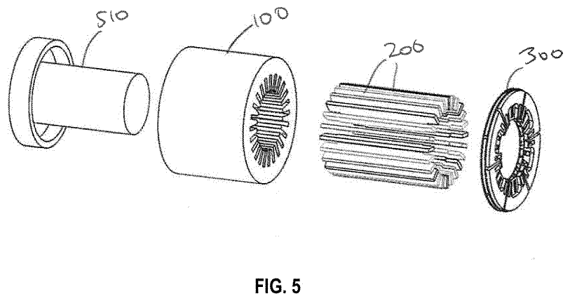

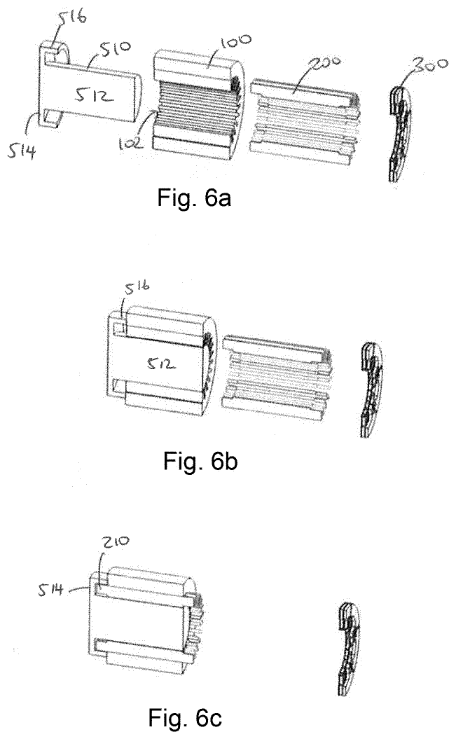

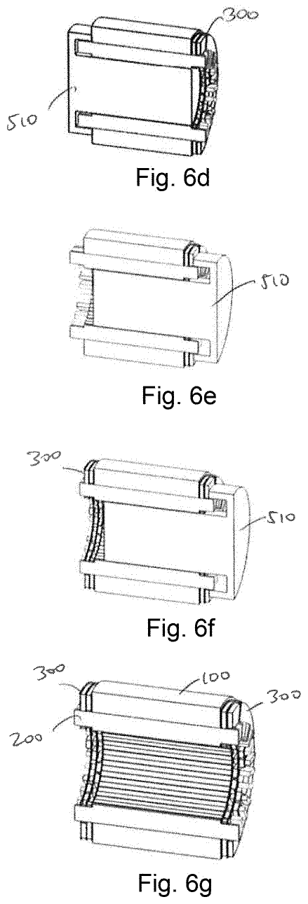

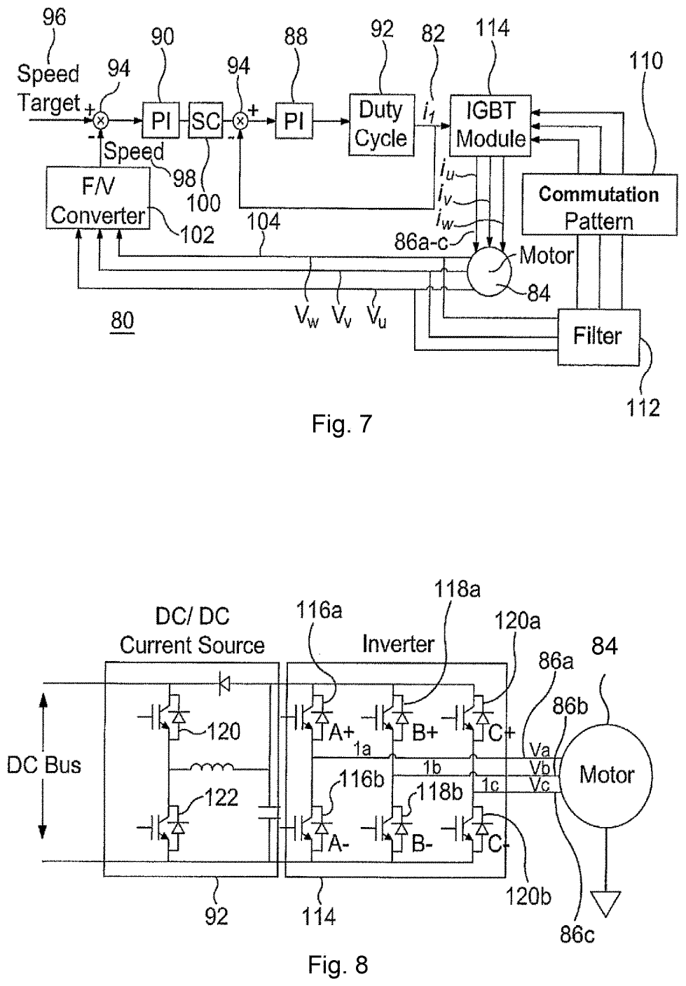

FIG. 8 highlights the duty cycle 92 and the IGBT module 114. The duty cycle 92 acts as a “DC/DC current source” part and creates a nearly continuous current of controlled aggregate amperage 82. The duty cycle has two IGBTs 120, 122 and by switching on and off the IGBTs, the aggregate current 82 can be regulated. The duty cycle 92 is connected to the IGBT module 114, which acts for a three phase signal as a six-leg inverter. Because of the high fundamental frequency of the motor, this IGBT module 114 only controls the commutation, and need never interrupt the aggregate flow of current to control power (as it would have to do in a more conventional control layout). The “inverter” part takes as input a commutation signal from a digital controller (not shown) and the aggregate current 82 produced by the duty cycle 92.

As output, the IGBT module 114 produces square wave current signals to drive the PM motor. The function of the IGBT module 114 is to deliver whatever aggregate current 82 is available from the duty cycle 92 directly to the motor 84 using a simple switching pattern. For each phase of current 86a-c, two IGBT's are provided. The commutation pattern for current iu 86a is provided by IGBT's 116a, 116b that switch on and off the aggregate current 82 supply to the required commutation pattern 110. Similar IGBT's 118a, 118b, 120a, 120b perform the same function for each additional phase of current iv 86b, iw 86c. Therefore the current supplied by each phase can be either positive, negative or zero.

It can be appreciated that an electric machine comprising the stator as described above in relation to any earlier figure may be envisaged. The electric machine may be a motor, generator, motor-generator or part of another system such as a forced induction system. The electric machine typically has a rotor having a plurality of magnetic pole pairs. The rotor may be located within the stator core or may be inverted depending upon the application and electric machine envisaged. A controller as described above may also be provided, electrically connected to said stator.

The construction method described herein greatly simplifies the construction of a stator negating the need for detailed motor winding patterns that typically require robotic construction and a large amount of time to design and construct.

From reading the present disclosure, other variations and modifications will be apparent to the skilled person. Such variations and modifications may involve equivalent and other features which are already known in the art of electrical machines, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality and reference signs in the claims shall not be construed as limiting the scope of the claims.

1. An electric machine comprising:
a stator, said stator comprising:
a cylindrical stator core having an end face;
slots provided on the end face, each slot running through the stator core;
a plurality of conductor bars disposed within the slots; and
an end face assembly electrically connecting at least two of the conductor bars, wherein the end face assembly comprises a circuit board, wherein then circuit board comprises:
one or more electrical pathways, each electrical pathway electrically connecting two or more conductor bars; and
an external electrical connection for energizing the connector bars;
a rotor having a plurality of magnetic pole pairs; and
a controller directly electrically connected to said circuit board for regulating an excitation current supplied to or from the conductor bars, wherein the controller regulates an amplitude of the excitation current independently of a frequency of the excitation current.

2. A machine according to claim 1, wherein the plurality of conductor bars fills between approximately 60% to 90% of the volume of the slot.

3. A machine according to claim 1, wherein one or two conductor bars are provided per slot.

4. A machine according to claim 1, wherein an end of at least two conductor bars protrudes outwardly from the end face, and wherein the end face assembly electrically connected to said conductor bars receives the ends of the conductor bars.

5. A machine according to claim 1, wherein the excitation current comprises a plurality of phases and wherein the controller is configured to supply the same phase of excitation current to each conductor bar disposed within a slot.

6. A machine according to claim 1, wherein pluralities of slots form one or more electrical slot groupings, each grouping being electrically connected to the controller in series, independently of other groupings.

7. A machine according to claim 6, wherein each electrical slot grouping is energized by an excitation current having a separate electrical phase.

8. A machine according to claim 1, wherein the controller comprises:
a power supply for supplying an excitation current to the conductors bars; and
a commutation controller, operationally independent of the power supply, and operative to control a timing and duration of supply of the excitation current to different conductor bars of the stator at any given time,

9. A machine according to claim 8, wherein the power supply comprises a current supply controller to control the amplitude of the current supplied to the conductor bars; and
wherein the current supply controller comprises a regulating current supply feedback loop for regulating the current amplitude supplied to the conductor bars dependent on a target speed of the electric machine.

10. A machine as claimed in claim 1, wherein the end face assembly comprises one or more end face conductors for electrically connecting the conductor bars.

11. A machine as claimed in claim 10, wherein each end face conductor comprises a conductive material encased in insulating material such that each end face conductor is electrically isolated.

12. A machine as claimed claim 10, wherein each or the end face conductor is arranged to electrically connect two or more conductor bars to a single phase electrical signal.

13. A machine as claimed in claim 12, wherein each or the end face conductor is segmented to form a discontinuous surface.

14. A machine according to claim 1, wherein the end face assembly is configured to receive a thermal plate to cool the end face assembly.

15. A machine according to claim 1, wherein the end face assembly is provided with a plurality of cooling channels for receiving a cooling fluid from a cooling system.

16. A machine according to claim 1, wherein each electrical pathway electrically connecting conductor bars to a separate phase of an electrical supply.

17. A stator for a high speed, low inductance electric machine, said stator comprising:
a cylindrical stator core having an end face;
slots provided on the end face, each slot running through the stator core;
a plurality of conductor bars disposed within each slot;
an end face assembly, said end face assembly electrically connecting at least two of the conductor bars; and
wherein the plurality of conductor bars disposed within a slot are electrically connected to a single electrical phase of an excitation current.
wherein an end of each bar protrudes outwardly from the end face receiving the ends of all the conductor bars

18. A method of manufacturing a stator for an electric machine, said method comprising the steps of:
providing a cylindrical stator stack, said stack having a hollow core and a plurality of slots provided on an end face, through the core, and around the core;
mounting said stack on a stator assembly tool, said tool having a protrusion that is received within the core;
inserting a plurality of conductor bars within the plurality of slots; and
placing an end face assembly over the end face, said end face assembly electrically connecting two or more conductor bars.

19. A method according to claim 18, wherein the conductor bars are longer than a length of said stator stack such that end portions of the conductors protrude beyond said slots away from said end face.
